(19) United States
(12) Patent Application Publication
(10) Pub. No.: US 2024/0403551 A1
(43) Pub. Date: Dec. 5, 2024

(54) USING LARGE LANGUAGE MODEL-GENERATED DESCRIPTIONS IN A CONTENT REPOSITORY

(71) Applicant: Highspot, Inc., Seattle, WA (US)

(72) Inventors: Kurt William Berglund, Kirkland, WA (US); Md Tanvir Islam Aumi, Redmond, WA (US); Caitlin Rollman, Seattle, WA (US); Haohua Huang, Seattle, WA (US)

(21) Appl. No.: 18/679,206

(22) Filed: May 30, 2024

Related U.S. Application Data
(60) Provisional application No. 63/505,403, filed on May 31, 2023.

(51) Int. Cl. G06F 40/20

(52) U.S. Cl. CPC G06F 40/20

(57) ABSTRACT

A system automatically generates descriptions for content items in a content item repository that include a summary of subject matter of a content item or key highlights from the content item, as well as an explanation of how the content item should be used. The system accesses a first content item from the repository and sends at least a portion to a large language model (LLM) to cause the LLM to generate a description for the first content item. The system stores the description for the first content item as metadata associated with the first content item. Using the description, the system can generate a second content item based on the first content item, perform efficient searches of the content repository, or identify similar content items.

### CROSS-REFERENCE TO RELATED APPLICATION

This application claims the benefit of U.S. Provisional Patent Application No. 63/505,403, filed May 31, 2023, which is incorporated herein by reference in its entirety.

### BRIEF DESCRIPTION OF THE DRAWINGS

Detailed descriptions of implementations of the present invention will be described and explained through the use of the accompanying drawings.

FIG. 1 is a block diagram illustrating an environment in which content item descriptions are generated and used, according to some implementations.

FIG. 2 is an interaction diagram illustrating a process for generating and using content item descriptions, according to some implementations.

FIGS. 3A-3B illustrate an example user interface in which content item metadata is created or modified.

FIG. 3C illustrates an example user interface for generating a message based on content item descriptions.

FIG. 4 is a block diagram of a transformer neural network, which may be used in examples of the present disclosure.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the modern digital era, many organizations rely on large content repositories to maintain their digital content. These repositories can accommodate an immense volume of data, encompassing a wide array of formats, from text documents and spreadsheets to multimedia files and more. Organizations often grapple with the complexities of managing these content repositories. Operations such as searching, categorizing, and analyzing the content can be computationally expensive given the scale of the repositories. These operations become further complicated when content is stored in various formats that each require different methods for retrieval and analysis that are often incompatible.

To solve these challenges, a content management system uses a large language model (LLM) to generate descriptions for content items stored by or available to the content management system. The description of a content item can include a summary of subject matter of the content item or key highlights from the content item, as well as an explanation of how the content item should be used. The explanation of how the content item should be used can include a purpose of the content item and/or a target audience for the content item. For example, the description can explain that a content item is “an outline of the 2023 version of the Strategic Framework for company executives,” “an introduction to Company A's sales management tools for sales representatives,” or “a technical presentation on new designs for Product X for engineers.” Descriptions can also include information that, for example, differentiates a content item from other similar content items, shares a cadence of updating of the content item, identifies when a content item is an outdated version of a newer content item or vice versa, or provides other details that may be salient for a user to quickly understand the content of a content item and how the content item should be used. The descriptions provide uniform data for items in the content repository, regardless of the format or content type of the underlying content items. This uniform data enables more efficient operation of a content repository, such as improving search within the repository and enabling the content management system to better identify content items that are similar or related to one another.

In some aspects, the techniques described herein relate to a computer-implemented method, a non-transitory computer-readable storage medium, and a data processing system that access a first content item from a content repository maintained by a content management platform. At least a portion of the first content item is sent to a large language model (LLM) to cause the LLM to generate a description for the first content item. The description for the first content item is stored as metadata associated with the first content item in the content repository. The description can then be used to improve operations within the content management platform. For example, the platform can use the description of a first content item to generate a second content item based on the first. The platform can additionally or alternatively use content item descriptions to efficiently search the content repository or to identify similar content items.

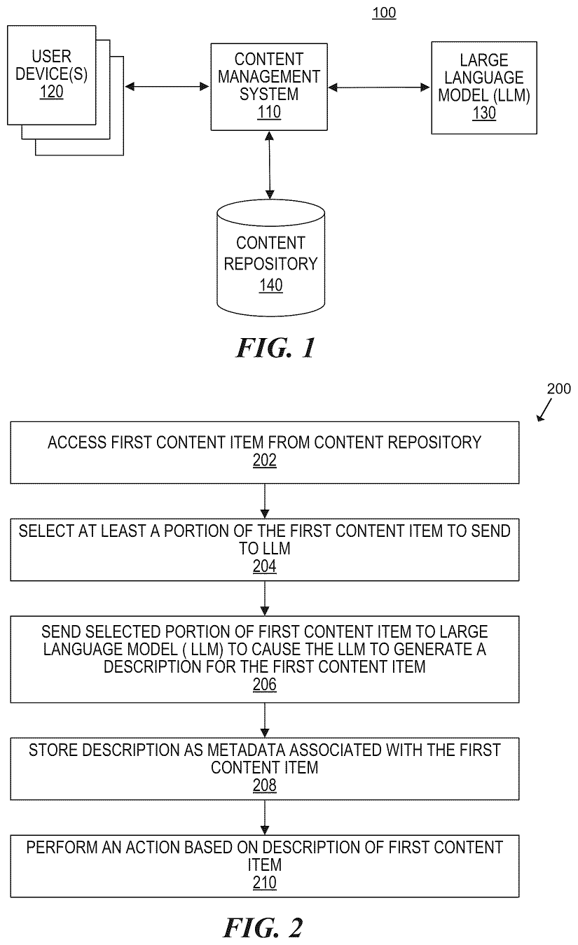

FIG. 1 is a block diagram illustrating an environment 100 in which content item descriptions are generated and used. As shown in FIG. 1, the environment can include a content management system 110, user devices 120, and a large language model (LLM) 130. The content management system maintains, or is configured to access, a content repository 140 that stores content and associated content metadata, including descriptions of the associated content.

The content management system 110 enables access to content items in the content repository. The content management system 110 can provide user interfaces via a web portal or application, which are accessed by the user devices to enable users to create content items, view content items, share content items, or search content items. In some implementations, the content management system includes enterprise software that manages access to a company's private data repositories and controls access rights with respect to content items in the repositories. However, the content management system can include any system or combination of systems that can access a repository of content items, whether that repository stores private files of a user (e.g., maintained on an individual's hard drive or in a private cloud account), private files of a company or organization (e.g., maintained on an enterprise's cloud storage), public files (e.g., a content repository for a social media site, or any content publicly available on the Internet), or a combination of public and private data repositories.

The content repository 140 stores content items such as documents, videos, images, audio recordings, 3D renderings, 3D models, or immersive content files (e.g., metaverse files). Documents stored in the content repository can include, for example, technical reports, sales brochures, books, web pages, transcriptions of video or audio recordings, presentations, or any other type of document. In some implementations, the content management system 110 enables users to add content items in the content repository to a person collection of items. These collections, referred to herein as “spots” or “lists,” can include links to content items in the content repository, copies of items in the content repository, and/or external content items (or links to external content items) that are not stored in the content repository. Users can create spots or lists for their own purposes (e.g., to keep track of important content items), for organizing content items around a particular topic (e.g., to maintain a set of content items that are shared whenever a new client is onboarded), for sharing a set of content items with other users, or for other purposes. In some cases, users may be able to access the spot created by other users. Additionally, some spots or lists can be generated automatically by the content management system 110, or the system 110 can supplement user-generated spots or lists with additional content items.

The content management system 110 can provide interfaces for users to interact with content in the content repository, such as interfaces that enable users to view, create, modify, or share content items. Alternatively, the content management system 110 maintains a set of APIs that enable other services, such as a native filesystem on a user device, to access the content items in the content repository and facilitate user interaction with the content items.

The content management system 110 can maintain interaction data quantifying how users interact with the content items in the content repository. Interaction data for a content item can include, for example, a number of users who have viewed the item, user dwell time within the item (represented as dwell time in the content item overall and/or as dwell time on specific pages or within particular sections of the content item), number of times the item has been shared with internal or external users, number of times the item has been bookmarked by a user or added to a user's collection of content items (a spot or list), number of times an item has been edited, number of times an item has been clicked/highlighted/otherwise emphasized, type and nature of edits/interaction, areas of content where the user hovered/paid more attention to, etc. When the content repository stores files of a company or organization, the interaction data can be differentiated according to how users inside the company or organization interact with the content and how users outside the company or organization interact with it.

The content management platform 110 may integrate with or receive data from external applications on the user device or provided by a third-party service. For example, the content management platform 110 may integrate with an electronic communication application, such as an email client, that enables the content management platform 110 to generate and send messages via the application. In another example, instead of integrating with a platform that maintains calendar or communication data, the content management platform 110 receives calendar or communication data that indicates, for example, the number of times a given sender has communicated with a given recipient, frequency of such communications, nature of such communications, or a number of times the sender and recipient have scheduled meetings.

In an example use case, the content management platform 110 is a sales enablement platform. The platform can store various items that are used by a sales team or their customers, such as pitch decks, product materials, demonstration videos, or customer case studies. Members of the sales team can use the system 110 to organize and discover content related to the products or services being offered by the team, communicate with prospective customers, share content with potential and current customers, and access automated analytics and recommendations to improve sales performance. Meetings analyzed by the system 110 can include sales meetings, in which a member of a sales team communicates with customers or potential customers to, for example, pitch products or services or to answer questions. However, the system 110 can be used for similar purposes outside of sales enablement, including for workplace environments other than sales and for formal or informal educational environments.

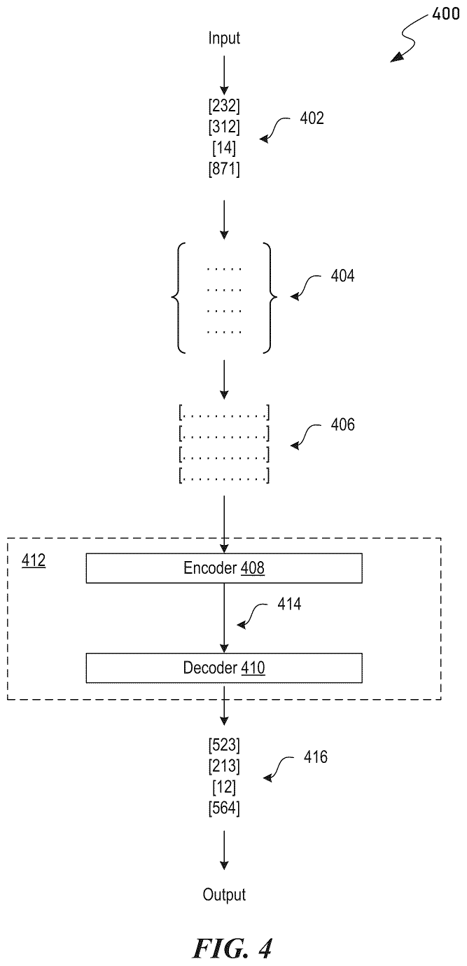

The LLM 130 can include one or more commercially available, fine-tuned, or custom language models that are configured to perform language analysis and generation tasks in response to prompts received from the content management platform 110. Example aspects of the LLM 130 are described with respect to FIG. 4.

The content management system 110 uses the LLM 130 to generate descriptions for content items in the content repository 140. The content management system can pre-process content items to prepare them for analysis by the LLM 130, such as transcribing audio into a document readable by the LLM 130, determining important sections longer or larger content items, or dividing longer or larger content items into smaller pieces. The content management system then sends at least a portion of the original or pre-processed content item to the LLM with a prompt instructing the LLM to generate a content item description.

### Generating and Using Content Item Descriptions

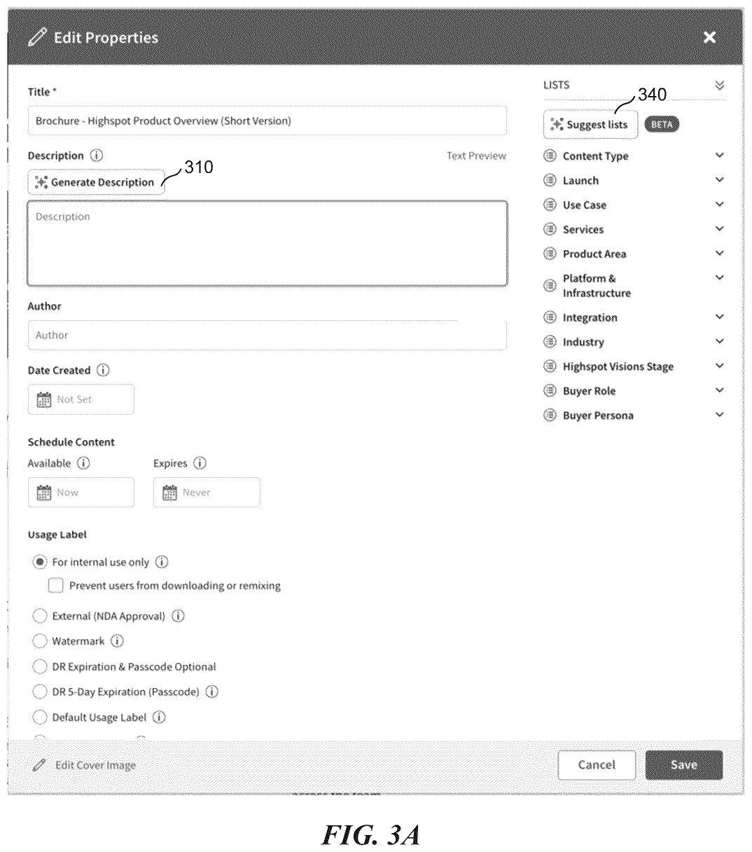

FIG. 2 is a flowchart illustrating a process 200 for generating and using content item descriptions, according to some implementations. The process shown in FIG. 2 can be performed by a computing device or system, such as the content management system. Other implementations of the process 200 can include additional, fewer, or different steps, or can perform the steps in different orders.

At 202, the content management system 110 accesses a first content item for which a description is to be generated. A first content item can be accessed when a user creates or uploads a new content item to the content repository. For example, the content management system guides a user through a upload process flow in which the system and/or user specify metadata for the content item such as title, subject matter, date of upload, or author. During this upload process flow, the system can automatically generate a description for the content item or can prompt the user to either enter a description or request automated generation of the description. The description generated by the content management system can be provided for review by the user during the upload process flow, enabling the user to modify the description or to request regeneration of the description. Alternatively, the content management system can generate descriptions for new content items by a batched process, for example by executing a batch process once per day to generate descriptions for any content items added to the repository that day.

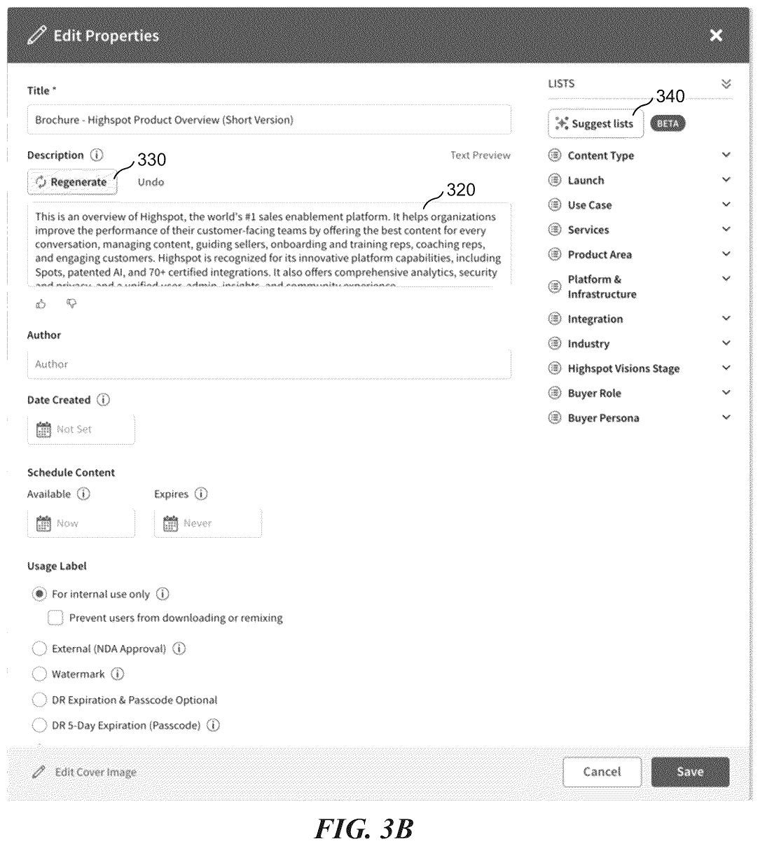

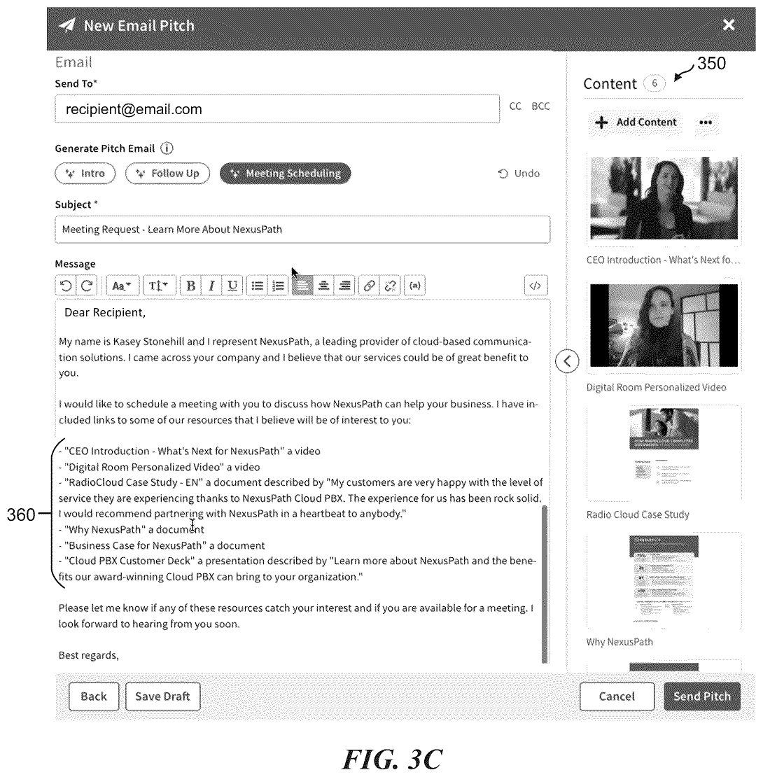

By way of example, FIGS. 3A-3B illustrate a user interface used to guide a user through a content item upload process. The user interface enables the user to define various metadata associated with the content item being uploaded, such as the title, author, date created, availability dates, usage labels, and a cover image for the item. The interface also includes an element 310 that, when selected, causes the content management system 110 to automatically generate the content item's description. As shown in FIG. 3B, the autogenerated description can be populated into a text box 320, where the user can modify the description if desired or select a “regenerate” option 330 to regenerate the description.

Instead of or in addition to leading a user through an upload process, the content management system 110 can access a first content item that is preexisting in the content repository for generating a new or modified description. In one example, the content management system detects that use data associated with a first content item in the content repository satisfies a criterion for generating a new description for the content item. Use data can include, for example, data indicating that a content item has been viewed, downloaded, or shared a specified number of times. A content item can instead be flagged for generating a new description if the content item has received greater than a threshold number of modifications since its existing description was generated, or if it receives a modification that is determined to be a substantive modification (e.g., if at least a specified volume of text in the content item was deleted or added). In another example, the content management system generates new content item descriptions for content items in the content repository on a periodic basis, such as once per year.

Users can also request a new description for a preexisting content item, in some implementations. For example, a user reading a document may request a description for the document. A user sharing a content item with another person may request a description to send to the other person with the content item.

The content management system 110 can access more than one content item for which a description is to be generated. For example, the content management system 110 can generate a description for a collection of multiple content items, such as a user-created list of items. Alternatively, the content management system may receive only a portion of a content item. For example, a user may request a description for a single chapter from a multi-chapter document.

Some content items may not include text, such as a video or audio recording. Although some LLMs may support video or audio inputs, other LLMs may not support inputs via these modalities. Thus, some implementations of the content management system 110 transcribe the video or audio recording into a text-based document that is readable by the LLM to generate a description of the content item.

At 204, the content management system selects at least a portion of the first content item that is to be sent to the LLM for generating the description. For some content items that are sufficiently short, the entire content item can feasibly be analyzed by the LLM. However, other content items may exceed a length constraint imposed by the LLM or may be longer than is practical to transmit or process in a reasonable time. Similarly, when a set of multiple content items is received, it may be impractical or infeasible to send the entire set of content items to the LLM at the same time due to constraints of the LLM and/or because they require extensive utilization of computing and networking resources. Furthermore, the content management system 110 can use data outside the content items themselves to identify important or relevant sections of the content items, which the LLM may not be able to determine when examining an entire content item on its own. Thus, in some implementations, the content management system selects a portion of a content item and/or a subset of a set of multiple content items to send to the LLM.

The content management system 110 can perform a reduction method on the first content item. For example, the system uses a framework or model, such as MapReduce, that maps the first content item to one or more reduced-size portions (such as 3000-word portions) that are sized to meet constraints of the LLM. The size of the portions can be further selected based on features such as importance of the content item, complexity of the content item, purpose for which the description is being generated, intended audience for the description, form of content dissemination, source or author of the content, or other factors. For example, larger portions can be used for more important content items or for dissemination methods that benefit from reduced amounts of text (such as email or SMS messages). Smaller portions may be used for more complex content items or when a content item is to be disseminated in a format that supports larger amounts of text, such as a webpage. The content management system may further reduce the content item into portions of multiple sizes, where the content in some of the portions may overlap.

When a content item is divided into multiple portions, each of the portions can be sent to the LLM to generate a summary. A refinement algorithm is then applied to summarize the summaries from each of the portions and to generate a description for the content item as a whole based on the portion summaries. For example, the content management system 110 can generate another prompt to the LLM that causes the LLM to summarizes the portion summaries. The content management system 110 can additionally or alternatively evaluate the portion summaries to, for example, remove redundant content, identify portion summaries that have similar content (e.g., if two summaries have a cosine similarity that is greater than a first threshold), or identify portion summaries that have highly dissimilar content (e.g., if two summaries have a cosine similarity that is less than a second threshold). Rules in the content management system may then cause the system to, for example, discard a summary if it is too dissimilar to summaries (e.g., less than a threshold cosine similarity) or discard a summary that is too similar to other summaries (e.g., greater than a threshold cosine similarity), before sending any remaining summaries to the LLM for analysis.

In other implementations, the content management system 110 uses use-data associated with a content item to determine sections that are likely to be the most important sections of the content item or the most salient for a particular purpose. For example, the content management system may maintain dwell time data that indicates which content items were viewed by users, how many users viewed the content item, and dwell time within the content item for the users who accessed it (expressed, for example, as an average view time across all users, an average across a certain set of users, or minimum or maximum dwell times). In some cases, the content management system 110 may also have dwell time data within a content item that provides, for example, information about dwell time on particular pages of a content item or within particular sections (e.g., chapters) of a content item. Using the dwell time data, the content management system 110 can select a portion of a content item that is likely the most salient to users of the content item, and thus is likely representative of the content item for generating a summary. For example, the content management system 110 selects a portion of the content item within which at least a threshold number of users have dwelled for at least a threshold amount of time. Alternatively, the content management system selects a section of the content item for which the number of user views or average dwell time is greater than another section of the content item, or greater than an average across the content item.

In still other implementations, the content management system 110 applies one or more rules or heuristics to select a portion of a content item to send to the LLM. For example, the content management system may apply a heuristic that predicts that the most important content of a content item will be found within the first few pages of the content item or within sections with certain titles, such as “introduction,” “executive summary,” or “conclusion.”

At 206, the content management system sends the one or more selected portions of the first content item to the LLM 130 with a prompt that instructs the LLM to generate a description for the first content item based on the selected portion(s). The prompt instructs the LLM to identify key highlights of the content item, purpose of the content item's content, and/or audience for the content item. The prompt can additionally specify parameters for the description, such as a length of the description, language for the description (e.g., the description should be in the same language as the content item), tone of the description (e.g., the description should be in the same tone or writing style as the content item, or should have a particular tone because a user requested a description for a particular purpose). In response, the LLM generates the description of the content item.

In some implementations, the content management system 110 prompts the LLM 130 to generate different descriptions for different purposes. For example, for the description of a content item to be used internally within a company that created the content item, the system may prompt the LLM to generate a description that includes information such as the cadence of updating or differentiation from other similar content items. For a description of the content item to be used externally, such as when the content item is shared with clients or customers of the company, the system prompts the LLM to generate a description that omits these details.

Once a description has been generated, the content management system 110 stores the description as metadata associated with the first content item in the content repository 140, at 208.

The system 110 then performs an action based on the description of the first content item in the content repository, at 210. Actions can include using the description to generate additional content items, using the description to perform searches of the content repository, or using the description identify similar content items (e.g., to categorize the first content item or to de-duplicate content items in the repository 140).

In some implementations, the content management system 110 uses the LLM 130 to generate a second content item, based at least in part on the description of the first content item. In one example, a user of the system 110 wants to share the first content item with another user, and uses the content management system 110 to generate a message for sharing the first content item with the other user. Messages can include, for example, email messages, social media posts, SMS messages, or messages transmitted within proprietary services such as Slack, Signal, WeChat, or WhatsApp. An example interface for generating an electronic message is illustrated in FIG. 3C. As shown, a user can select one or more content items 350. The system sends the description of the selected content items to the LLM to cause the LLM to automatically generate a message that explains each content item and its salience to the recipient of the message. An example message, with content item explanations 360, is also shown in FIG. 3C. Rather than sending the entirety of each content item to the LLM to generate this message, the content management system can send the LLM the descriptions of the items, which takes less time and computing power to process than the entire content items.

The content management system 110 can generate any of a variety of other types of second content items based on the first content item. In some cases, the first content item is a first type of content item and the content management system 110 generates a second content item of a different type, based at least in part on the description of the first content item. For example, when the first content item is a long document with multiple sections or chapters, the content management system 110 generates a description for each chapter and then uses the chapter descriptions to generate a slide deck that summarizes the document. The content management system 110 can instead generate a video summary or audio summary of a document, for example. In another example, the first content item is a recording of one of several meetings held between salespeople in an organization and prospective customers outside the organization, as part of a particular sales campaign. Based on descriptions of each of the meeting content items, the system 110 can generate a second content item that summarizes the sales campaign.

In other implementations, the descriptions generated by the content management system 110 and LLM 130 can be used to facilitate searches of the content repository 140. A user, for example, can submit a search query to the system when searching for an answer to a question or searching for a content item to use in a particular circumstance. When a search query is received, the content management system 110 can perform string-based, semantic, or vector-based searches of the content item descriptions in order to find content items that match the search query.

For example, when the content management system receives a search query for Topic A, the content management system may search content item descriptions to identify descriptions that contain the string “Topic A” or are semantically related to Topic A. This search of descriptions can be performed before, instead of, or in addition to searching the full text of a set of content items for the topic. Such search functionality can be predicated on a determination that a content item is likely to be more relevant to Topic A if the topic is described in the content item's description, than if the topic only appears in the full text of the content item. Searching content item descriptions is likely to be faster than a search performed on full content items, and thus such searches can quickly and computationally efficiently return the most relevant results. A search for highly relevant content can thus be rapidly performed.

In another example, performing searches of content item descriptions can enable the content management system 110 to return relevant search results in response to queries for data that may or may not be explicitly provided within the content items themselves, such as target audience for a content item or how content items are to be used. For example, if a user queries the system 110 for “a pitch deck for Product A that can be shared with potential customers” or “engineering documentation for Product A,” the system 110 can perform a simple semantic search of content item descriptions to identify content items that are relevant to each of these different target audiences and purposes.

In some implementations, the content management system 110 uses a content item description of a first content item to add the first item to a list with other content items. Lists within the content management system 110 can each include two or more content items that are related to each other in some way. Two content items may be related, for example, because they describe similar subject matter (such as the same product). Other content items may be related because they are used in similar ways (such as materials that are shared whenever a new client is onboarded to an organization). Still other content items may be related because they have similar audiences, are authored by the same user or same group of users, or were created around the same time or as part of the same project. Content items can also have multidimensional similarity where, for example, they are similar both in the subject matter they describe and the audience they target.

The system 110 can automatically add the first content item to a list, or can recommend to a user that the first content item be added to a list, based on a degree of similarity between the first content item and the other content items in the list. For example, in the content upload user interface shown in FIGS. 3A-3B, a “Suggest Lists” option 340 is provided. When the option 340 is selected, the content management system 110 generates a recommendation for one or more lists to which the content item should be added. In some implementations, the system 110 uses the description of the first content item and descriptions of content items in a first list to generate vectors that represent each content item (such as embeddings generated by the LLM or by techniques such as word2vec). If a similarity metric (e.g., cosine similarity) between the vectors of the items already in the first list and the vector of the first content item is within a specified threshold, the system 110 can recommend that the first content item be added to the first list. Any of a variety of other similarity metrics can be used to determine overall similarity between two content items, including semantic or string-based methods. Some of these similarity metrics can use additional attributes or metadata associated with the content items, in addition to the descriptions of the items, in order to determine when to recommend that a content item be added to a list. Similarly, the content management system 110 can recommend that a new list be formed with the first content item and a second content item, based on a degree of similarity between the descriptions of the first and second items.

In some implementations, the content management system uses content item descriptions to deduplicate a set of content items. The content management system can apply a clustering algorithm that uses the descriptions of content items in the content repository to generate clusters of similar content items. Once a cluster has been identified, the content management system can use the rest of the content of the content item, content item metadata, or other signals to determine if differences exist between content items in the cluster.

The description generated for a content item can be updated over time as the content of the content item changes or as users interact with the content item. For example, as described above, the content management system may generate, periodically or upon satisfaction of a criterion, a new description for a content item to capture any changes in the content of the content item or its use since the last time the description was generated. Similarly, as content items are added to or removed from a collection of content items (such as a spot), the system can generate a new description for the collection that represents the set of content items in the collection.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 4 is a block diagram of an example transformer 412. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 412 includes an encoder 408 (which can include one or more encoder layers/blocks connected in series) and a decoder 410 (which can include one or more decoder layers/blocks connected in series). Generally, the encoder 408 and the decoder 410 each include multiple neural network layers, at least one of which can be a self-attention layer. The parameters of the neural network layers can be referred to as the parameters of the language model.

The transformer 412 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 412 is trained to perform certain functions on other input formats than natural language input. For example, the input can include objects, images, audio content, or video content, or a combination thereof.

The transformer 412 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 4 illustrates an example of how the transformer 412 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 4, a short sequence of tokens 402 corresponding to the input text is illustrated as input to the transformer 412. Tokenization of the text sequence into the tokens 402 can be performed by some pre-processing tokenization module such as, for example, a byte-pair encoding tokenizer (the “pre” referring to the tokenization occurring prior to the processing of the tokenized input by the LLM), which is not shown in FIG. 4 for brevity. In general, the token sequence that is inputted to the transformer 412 can be of any length up to a maximum length defined based on the dimensions of the transformer 412. Each token 402 in the token sequence is converted into an embedding vector 406 (also referred to as “embedding 406”).

An embedding 406 is a learned numerical representation (such as, for example, a vector) of a token that captures some semantic meaning of the text segment represented by the token 402. The embedding 406 represents the text segment corresponding to the token 402 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 406 corresponding to the “write” token will be closer to another embedding corresponding to the “jot down” token in the vector space as compared to the distance between the embedding 406 corresponding to the “write” token and another embedding corresponding to the “summary” token.

The vector space can be defined by the dimensions and values of the embedding vectors. Various techniques can be used to convert a token 402 to an embedding 406. For example, another trained ML model can be used to convert the token 402 into an embedding 406. In particular, another trained ML model can be used to convert the token 402 into an embedding 406 in a way that encodes additional information into the embedding 406 (e.g., a trained ML model can encode positional information about the position of the token 402 in the text sequence into the embedding 406). In some implementations, the numerical value of the token 402 can be used to look up the corresponding embedding in an embedding matrix 404, which can be learned during training of the transformer 412.

The generated embeddings 406 are input into the encoder 408. The encoder 408 serves to encode the embeddings 406 into feature vectors 414 that represent the latent features of the embeddings 406. The encoder 408 can encode positional information (i.e., information about the sequence of the input) in the feature vectors 414. The feature vectors 414 can have very high dimensionality (e.g., on the order of thousands or tens of thousands), with each element in a feature vector 414 corresponding to a respective feature. The numerical weight of each element in a feature vector 414 represents the importance of the corresponding feature. The space of all possible feature vectors 414 that can be generated by the encoder 408 can be referred to as a latent space or feature space.

Conceptually, the decoder 410 is designed to map the features represented by the feature vectors 414 into meaningful output, which can depend on the task that was assigned to the transformer 412. For example, if the transformer 412 is used for a translation task, the decoder 410 can map the feature vectors 414 into text output in a target language different from the language of the original tokens 402. Generally, in a generative language model, the decoder 410 serves to decode the feature vectors 414 into a sequence of tokens. The decoder 410 can generate output tokens 416 one by one. Each output token 416 can be fed back as input to the decoder 410 in order to generate the next output token 416. By feeding back the generated output and applying self-attention, the decoder 410 can generate a sequence of output tokens 416 that has sequential meaning (e.g., the resulting output text sequence is understandable as a sentence and obeys grammatical rules). The decoder 410 can generate output tokens 416 until a special [EOT] token (indicating the end of the text) is generated. The resulting sequence of output tokens 416 can then be converted to a text sequence in post-processing. For example, each output token 416 can be an integer number that corresponds to a vocabulary index. By looking up the text segment using the vocabulary index, the text segment corresponding to each output token 416 can be retrieved, the text segments can be concatenated together, and the final output text sequence can be obtained.

In some implementations, the input provided to the transformer 412 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

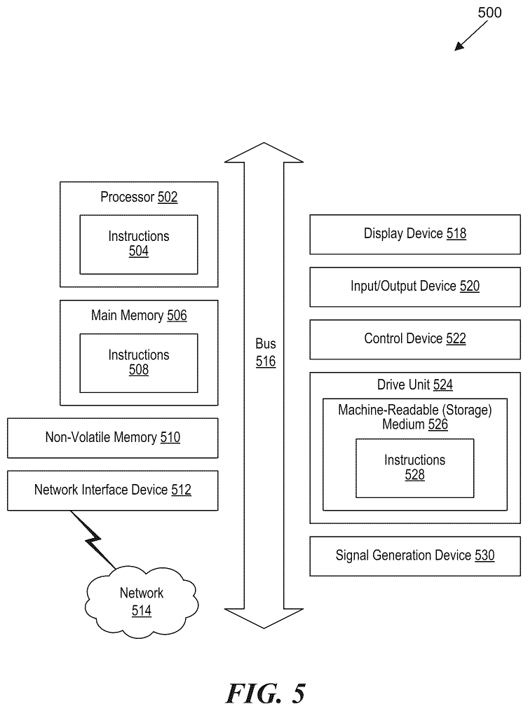

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### REMARKS

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A computer-implemented method, comprising:
accessing, by a computer system associated with a content management platform, a first content item from a content repository maintained by the content management platform;
retrieving, by the computer system, use data associated with the first content item that characterizes user activity with respect to the first content item;
sending at least a portion of the first content item to a large language model (LLM) to cause the LLM to generate a description for the first content item;
wherein sending at least the portion of the first content item to the LLM comprises sending the use data associated with the first content item to cause the LLM to generate the description for the first content item based in part on the use data
storing, by the computer system, the description for the first content item as metadata associated with the first content item in the content repository; and
upon receiving a request to generate a second content item based on the first content item, sending, to the LLM, a prompt that includes the description for the first content item and that instructs the LLM to use the description to generate the second content item.

2. The computer-implemented method of claim 1, further comprising:
selecting the portion of the first content item to send to the LLM based on the use data.

3. The computer-implemented method of claim 2, wherein the use data includes dwell time by a plurality of users in different sections of the first content item, and wherein selecting the portion of the first content item based on the use data comprises:
determining, based on the use data, a first section of the first content item for which an average of the dwell time of the plurality of users in the first section is higher than an average dwell time of the plurality of users in a second section of the first content item; and
selecting the first section of the first content item as the portion to send to the LLM.

4. The computer-implemented method of claim 1, wherein sending at least the portion of the first content item to the LLM comprises:
applying a reduction method to the first content item to divide the first content item into multiple sections;
sending each of the multiple sections to the LLM to instruct the LLM to generate a respective summary of each section; and
refining the summaries of each of the multiple sections to generate the description for the first content item.

5. The computer-implemented method of claim 1, wherein sending the LLM the prompt instructing the LLM to generate the second content item comprises:
instructing the LLM to generate an electronic message based on the first content item, wherein the electronic message includes a summary of the first content item that is generated by the LLM based on the description of the first content item.

6. The computer-implemented method of claim 1, wherein the first content item is a first type of content item, and wherein sending the LLM the prompt instructing the LLM to generate the second content item comprises:
instructing the LLM to generate, as the second content item, a second type of content item to summarize the first content item, based on the description of the first content item.

7. The computer-implemented method of claim 1, wherein the first content item is accessed based on detecting the first content item is a new content item in the content repository.

8. The computer-implemented method of claim 1, further comprising:
retrieving, by the computer system, use data associated with the first content item that characterizes user activity with respect to the first content item;
wherein the first content item is accessed based on detecting the use data satisfies a criterion for generating a new description for the first content item.

9. The computer-implemented method of claim 1, wherein accessing the first content item comprises accessing a plurality of content items that includes the first content item, and wherein generating the description for the first content item comprises generating a description for the plurality of content items.

10. A non-transitory computer-readable storage medium storing executable computer program instructions, the computer program instructions when executed by one or more processors of a system causing the system to:
access a first content item from a content repository maintained by a content management platform;
retrieve use data associated with the first content item that characterizes user activity with respect to the first content item;
send at least a portion of the first content item to a large language model (LLM) to cause the LLM to generate a description for the first content item;
wherein sending at least the portion of the first content item to the LLM comprises sending the use data associated with the first content item to cause the LLM to generate the description for the first content item based in part on the use data;
store the description for the first content item as metadata associated with the first content item in the content repository;
receive a search query directed to the content repository; and
identify the first content item as a search result based at least in part on match between the search query and the description for the first content item.

11. The non-transitory computer-readable storage medium of claim 10, wherein the computer program instructions when executed by the one or more processors further cause the system to:
select the portion of the first content item to send to the LLM based on the use data.

12. The non-transitory computer-readable storage medium of claim 11, wherein the use data includes dwell time by a plurality of users in different sections of the first content item, and wherein selecting the portion of the first content item based on the use data comprises:
determining, based on the use data, a first section of the first content item for which an average of the dwell time of the plurality of users in the first section is higher than an average dwell time of the plurality of users in a second section of the first content item; and
selecting the first section of the first content item as the portion to send to the LLM.

13. The non-transitory computer-readable storage medium of claim 10:
wherein sending the use data associated with the first content item to cause the LLM to generate the description for the first content item based in part on the use data causes the LLM to generate the description that includes the use information:
wherein the search query includes a query for use information; and
wherein identifying the first content item as the search result comprises determining the use information in the description of the first content item is a match to the query for use information.

14. The non-transitory computer-readable storage medium of claim 10:
wherein sending at least the portion of the first content item to the LLM to cause the LLM to generate the description for the first content item comprises instructing the LLM to:
determine audience information that indicates an audience for the first content item; and
generate the description that includes the audience information;
wherein the search query includes a query for audience information; and
wherein identifying the first content item as the search result comprises determining the audience information in the description of the first content item is a match to the query for audience information.

15. A data processing system, comprising:
one or more processors; and
one or more non-transitory computer-readable storage media storing executable computer program instructions, the computer program instructions when executed by the one or more processors cause the data processing system to:
access a first content item from a content repository maintained by a content management platform;
wherein the content management platform maintains a plurality of lists that each include two or more content items related to one another;
send at least a portion of the first content item to a large language model (LLM) to cause the LLM to generate a description for the first content item;
store the description for the first content item as metadata associated with the first content item in the content repository; and
add the first content item to a first list of the plurality of lists based on a determined similarity between the description for the first content item and other content items in the first list.

16. The data processing system of claim 15, wherein the computer program instructions when executed by the one or more processors further cause the system to:
retrieve use data associated with the first content item that characterizes user activity with respect to the first content item;
wherein sending at least the portion of the first content item to the LLM comprises sending the use data associated with the first content item to cause the LLM to generate the description for the first content item based in part on the use data.

17. The data processing system of claim 15, wherein the computer program instructions when executed by the one or more processors further cause the system to:
select the portion of the first content item to send to the LLM based on the use data.

18. The data processing system of claim 17, wherein the use data includes dwell time by a plurality of users in different sections of the first content item, and wherein selecting the portion of the first content item based on the use data comprises:
determining, based on the use data, a first section of the first content item for which an average of the dwell time of the plurality of users in the first section is higher than an average dwell time of the plurality of users in a second section of the first content item; and
selecting the first section of the first content item as the portion to send to the LLM.

19. The data processing system of claim 15, wherein the first content item is accessed and added to the first list based on detecting the first content item is a new content item in the content repository.

20. The data processing system of claim 15:
wherein accessing the first content item comprises accessing a plurality of content items that includes the first content item,
wherein generating the description for the first content item comprises generating a description for the plurality of content items, and
wherein the plurality of content items are added to the first list based on the description.
